(19) United States
(12) Patent Application Publication
(10) Pub. No.: US 2006/0259293 A1
(43) Pub. Date: Nov. 16, 2006

(54) Computerized method and apparatus for automatically generating a natural language description of a person's activities

(75) Inventor: Jonathan Lee Orwant, Cambridge, MA (US)

Correspondence Address: COHEN, PONTANI, LIEBERMAN & PAVANE, Suite 1210, 551 Fifth Avenue, New York, NY, 10176, US

(73) Assignee: France Telecom, Paris (FR)

(21) Appl. No.: 11/127,976

(22) Filed: May 11, 2005

(51) Int. Cl. G06F 17/27

(52) U.S. Cl. 704/9

(57) ABSTRACT

A computerized method to gather, store and process data related to activities in which the person had been engaged, and to generate a natural language description summarizing the person's activities. The description can then be transmitted to a remote computer for use by various computer applications, such as a blog.

### FIELD OF THE INVENTION

The invention pertains to using a computer to gather, store and process data related to activities in which the person had been engaged, to generate a natural language description summarizing the person's activities, and to automatically transmit the description to a publication.

### BACKGROUND OF THE INVENTION

From time to time, web surfers may wish to read about the activities of fellow computer users for entertainment purposes. For example, a blog is a personal journal, accessible over the Internet, that is frequently updated and intended for general public consumption. Blogs typically represent the personality of the author or reflect the purpose of the Web site that hosts the blog. Topics include brief philosophical musings, commentary on social issues, and links to other Internet sites the author uses. The essential characteristics of the blog are its journal form, typically a new entry each day, and its informal style.

On a more utilitarian note, employers may wish to keep track of the activities of a large number of workers situated at a plurality of remote locations far removed from corporate headquarters. Likewise, parents may wish to keep track of the activities of teenagers or young children. In the aforementioned situations and many similar ones, it would be desirable to have knowledge of an activity, as well as the location or locations in which the activity took place. As used herein, the term “location” encompasses place categories such as home, school, work, or a shopping mall, as well as geographical locations such as Sydney, Australia. Illustrative activities include visiting a web site that lists stock prices, listening to a musical selection, or making a purchase at a grocery store.

Although it is possible to program a computer to generate electronic descriptions (data from which spoken words, and perhaps also written text, can be produced) of an individual's location and activities, these descriptions are of interest only if they include useful information that readers want to read about, and exclude information that readers do not want to read about. Existing techniques for generating electronic descriptions of an individual's activities are unable to discriminate between useful information and trivial information. For example, in the case of a web surfer reading about the activities of a fellow computer user, prior art description generating programs may include potentially entertaining information such as “I listened to Beethoven for the first time in several months”, as well as trivial information such as “I typed on my computer for 13 minutes and 44 seconds”.

Various prior art programs have been developed for condensing information from text documents so as to enable preparation of a summarized version of the document. For example, programs such as the Perl HTML::Summary module (available at http://search.cpan.org), the Classifier4J library (available at http://classifier4j.sourceforge.net), the OS X Summarization service (available on the OS X operating system that runs on Apple computers), the Sinope summarizer (available at http://www.sinope.info), the Open Text Summarizer (available at http://libots.sourceforge.net), and the summarization techniques disclosed in U.S. Pat. No. 6,401,086 are all capable of summarizing pre-existing text documents such as web pages, newspaper articles, or Word documents. However, none of these programs is equipped to distinguish between portions of text that include useful information and portions of text that are directed to trivial or unimportant subject matter. Identifying information that is useful to a reader is a difficult and complicated task for a computer program to perform.

These prior art programs have various other shortcomings. For example, they only operate on documents, and are not equipped to gather data related to the activities of an individual. The summaries provided by these programs are in a format that may be difficult for a human reader to comprehend. Moreover, no mechanism is provided for automatically transmitting document summaries for storage in a persistent medium.

### SUMMARY OF THE INVENTION

One object of the present invention is to automatically obtain data about a person's activities at periodic, repeated, or regularly occurring intervals of time, in order to facilitate the task of generating a description that summarizes activities in which the person had been engaged.

Another object of the present invention is to process the obtained data and to convert that data into a structured format, so as to enable an efficient analysis of the data.

A further object of the present invention is to summarize the data for use in providing a natural language description for reading by a human.

Another object of the present invention is to facilitate the storage of a description of a person's activities, and to store such a description for a substantial or indefinite period of time.

Still another object of the present invention is to transmit the description to a recipient based on an estimated importance of the described activity data.

These and other objects are attained in accordance with one aspect of the present invention directed to a technique for automatically composing a natural language summary of a person's activities, comprising the steps of obtaining data related to activities in which the person has engaged, distinguishing more meaningful data from less meaningful data contained in the obtained data, and composing a natural language summary of the person's activities from the more meaningful data.

Another aspect of the present invention directed to a technique, based on using data obtained about activities engaged in by a person, for distinguishing more meaningful data from less meaningful data contained in the obtained data, comprising the steps of: for each activity, determining a first weight based on the history of the person; for each activity, determining a second weight based on the history of a population; and for each activity, combining the first and second weights to derive an importance value.

Another aspect of the present invention directed to a technique, based on using data obtained about at least one activity engaged in by a person, for automatically composing a natural language summary of such at least one activity, comprising the steps of: creating a paragraph structure related to the at least one activity, creating a sentence structure to respectively summarize at least a component of the at least one activity, wherein the natural language used in the sentences is based on the obtained data, selecting verbs for insertion into said sentence structure, and selecting conjunctions for joining the paragraphs and/or sentences to form the summary.

### BRIEF DESCRIPTION OF THE DRAWINGS

FIG. 1 is a schematic block diagram showing an arrangement of components for implementing the invention.

FIG. 2 is a flowchart depicting operations performed by the system in accordance with the present invention.

FIG. 3 provides details of the SENSE operation shown in FIG. 2.

FIG. 4 provides details of the CONDENSE operation shown in FIG. 2.

FIG. 5 provides details of the DETERMINE IMPORTANCE operation shown in FIG. 2.

FIG. 6 provides details of the COMPOSE operation shown in FIG. 2.

FIG. 7 provides details of the TRANSMIT operation shown in FIG. 2.

FIG. 8 shows Table 1 which is a sample activity record made after observations of a person's activities have been condensed.

FIG. 9 shows Table 2 which is a sample activity record made after the condensed observations of a person's activities have been weighted with respect to their relative importance.

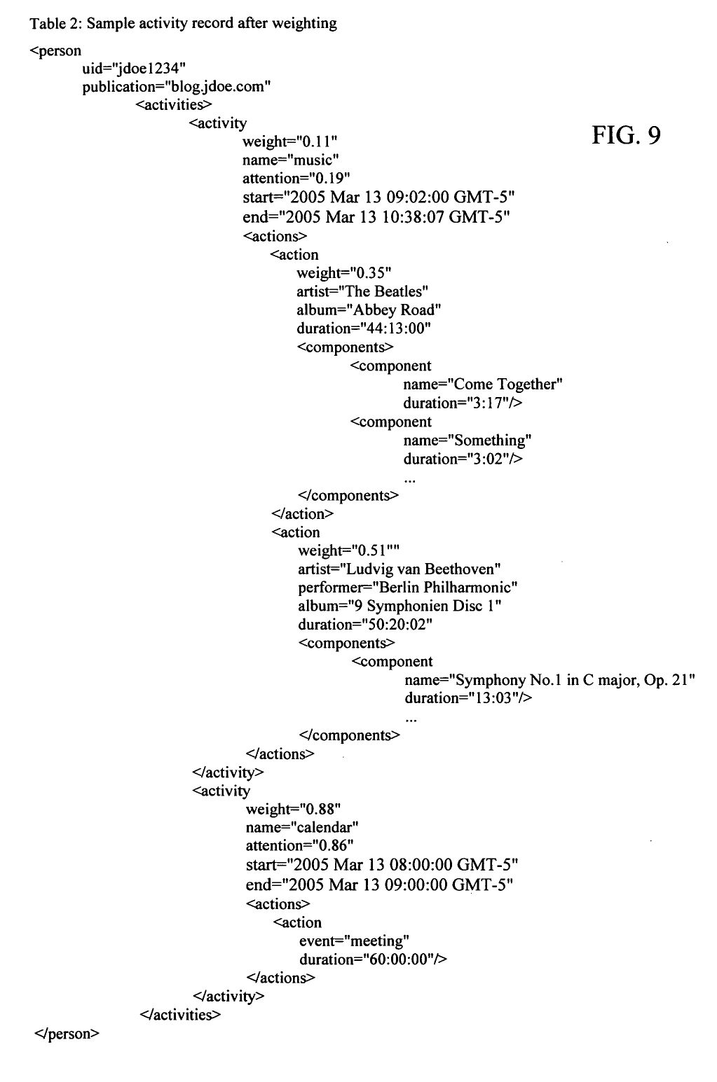

### DETAILED DESCRIPTION OF THE DRAWINGS

Terms used in the explanation of the invention as presented herein are defined as follows:

Activity: A commonly-recognized process, function, or task performed by a person. Examples are listening to music, driving to work, or attending a meeting.

Sensor: Hardware or software able to detect the current activity of a person and to output data corresponding thereto in machine-readable form. An example would be a software utility able to identify what music a person is listening to via his computer.

Action: Any component of an activity which is semantically meaningful in the sense that the component meets a minimum threshold of importance, where “minimum threshold” is defined by the heuristics described below. Examples are listening to an album, listening to a particular song, driving on a highway, or attending a session within a meeting. Examples of an action that is not semantically meaningful are that at 8:13 a.m. the person drove from 42.57234 latitude, −72.23425 longitude to 42.57236 latitude, −72.23421 longitude, or that at 9:27 a.m. the person listened to “Born to Run” from 0 minutes 43 seconds into the song to 1 minute 43 seconds into the song.

Observation: A machine-readable expression about a particular action. An observation can be the same as the sensor output data for a particular action.

Natural language: A conventional written or spoken language, such as English.

Publication: A collection of natural language text or speech suitable for dissemination to a large audience. Examples of publications include HTML files, MP3 files, Word documents, physical printouts, Morse code, and computer applications.

Blog: A publication consisting of an online sequence of natural language messages, arranged chronologically.

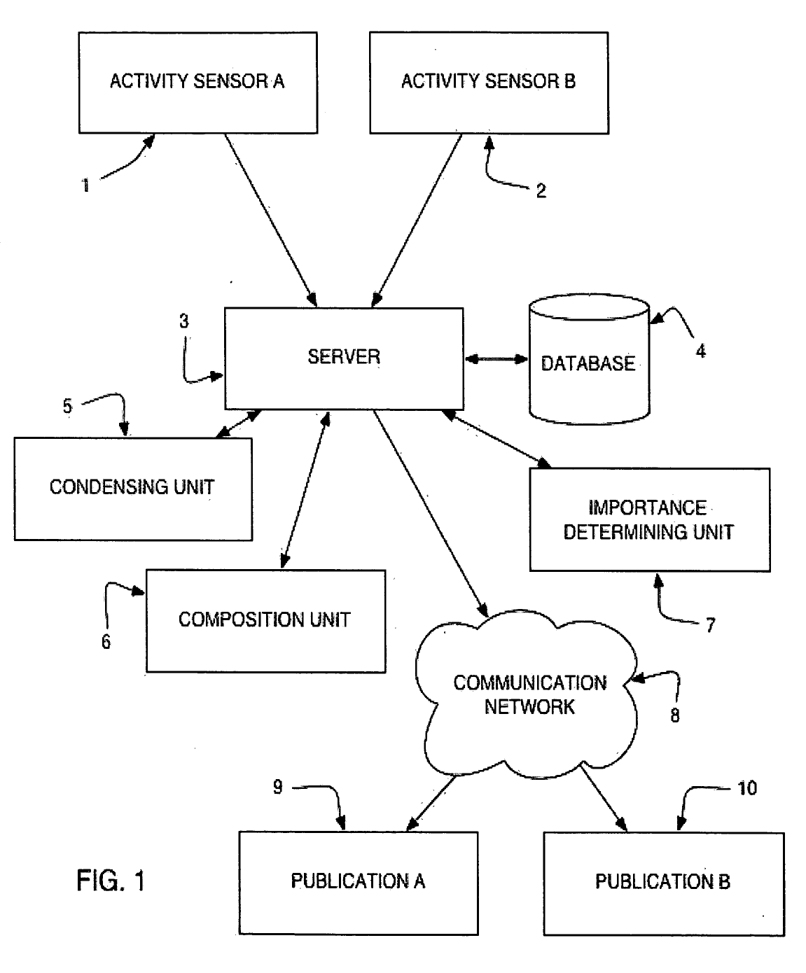

FIG. 1 is a schematic block diagram showing an arrangement of components for implementing an embodiment of the invention. Generally speaking, a local computing device gathers data electronically via sensors, organizes the gathered data into a structured form, converts the organized data into a natural language description which is stored in a database, and then transmits the description to a remote computer. The remote computer includes a remote server capable, for example, of hosting a blog (defined above). The local computing device uses an API (Application Programming Interface) designed for establishing a communications path over the Internet to the remote server hosting the blog, and then automatically transmitting the description to the remote computer after the communications path is established.

More specifically, server 3 (acting as the above-mentioned local computing device) receives data about the activities of a person from sensors 1, 2. Condensing unit 5 and importance determining unit 7 process the data, and the result is stored in database 4. Composition unit 6 creates a natural language description summarizing the activities of the person since the immediately preceding description was composed, and the server 3 transmits the description via communication network 8 to publications 9 and 10.

It should be understood that the number of sensors 1, 2 and publications 9, 10 usable with this invention is a matter of design choice. Although two sensors 1, 2 and two publications 9, 10 are shown for the sake of clarity in describing the invention, it should be clearly understood that use of any number of sensors and publications is possible. Likewise, it should be readily understood that the number of other types of publications usable with this invention is also a matter of design choice, and that only two publications are shown for the sake of clarity in describing the invention while making the point that a plurality of such publications is possible.

Activity sensors 1 and 2 obtain information about the activities of the person and generate data related thereto. The person's activities are performed, for example, with a personal computer (PC), a PDA, a mobile telephone or any other device that provides activity information as an output (e.g. a reading, measurement, indication) which can be detected by sensors 1, 2. In a preferred embodiment, activity sensors 1 and 2 are software programs written in the Perl programming language (available for free at http://www.perl.org) that sample online applications every 60 to 120 seconds. Examples of such sensors include a sensor that gathers information about music that the person is listening to from an application such as Apple iTunes, a sensor that gathers information about the person's agenda from a calendaring system such as Microsoft Outlook Calendar, and a sensor that gathers information about the person's whereabouts from a source of location information, such as a GPS receiver.

The data (i.e. in the form of an observation for each detected activity) from the sensors is provided, such as over a communications network (not shown), to server 3. The received observations serve to, for example, identify the person, the activity, and details of the use of the activity by the person, including such information as what the person was doing, when the activity began, when the activity ended, if the activity is ongoing, and the location of the person.

Server 3 can be, for example, a computer running a FreeBSD operating system and a MySQL database engine (available for free at http://www.mysql.com) for database 4 which records the observations in an XML (Extensible Markup Language) format. (See www.w3.org/XML.)

A sample record of observations can be as follows. For ease of reading, it is not presented in XML. Also, in this example, the calendar application activity sensor polls every minute, and the music sensor polls every 10 seconds. Of course, selection of other intervals is a matter of design choice.
08:00:00 Calendar application says: Person is attending a meeting
08:01:00 Calendar application says: Person is attending a meeting
08:02:00 Calendar application says: Person is attending a meeting
08:59:00 Calendar application says: Person is attending a meeting
09:02:00 Music application says: Person is listening to Come Together
09:02:10 Music application says: Person is listening to Come Together
09:02:20 Music application says: Person is listening to Come Together
09:02:30 Music application says: Person is listening to Come Together
09:48:20 Music application says: Person is listening to Symphony No. 1 in C major, Op. 21
09:48:30 Music application says: Person is listening to Symphony No. 1 in C major, Op. 21
09:48:40 Music application says: Person is listening to Symphony No. 1 in C major, Op. 21

Condensing unit 5 can be a Perl program running on server 3 that, at periodic or regular intervals (such as every hour), retrieves from database 4 all of the observations obtained since the last description was transmitted by server 3 across communication network 8 (such as the Internet). Condensing unit 5 then combines the observations into larger and more encompassing XML documents that integrate multiple observations into sets of observations that determine when information should be combined. Such sets of observations are shown just above. This integration is performed using a set of heuristics. The heuristics are expressions of the common-sense usages of a medium, e.g. just simple rules of thumb. For music, examples of heuristics include: music is reproduced by playing albums, an album has an artist, and an album contains songs. For transportation, heuristics include: assertions about the typical speeds of airplanes, and that a person cannot be in two places at the same time, etc. Consequently, when the system observes the person listening to multiple songs from the same album, it it infers an action as a result, namely that the person is listening to the album. Likewise, if the person proceeded to listen to other albums immediately afterward, those observations would result in the inference that the person listened to music from, say, noon to 6 P.M.

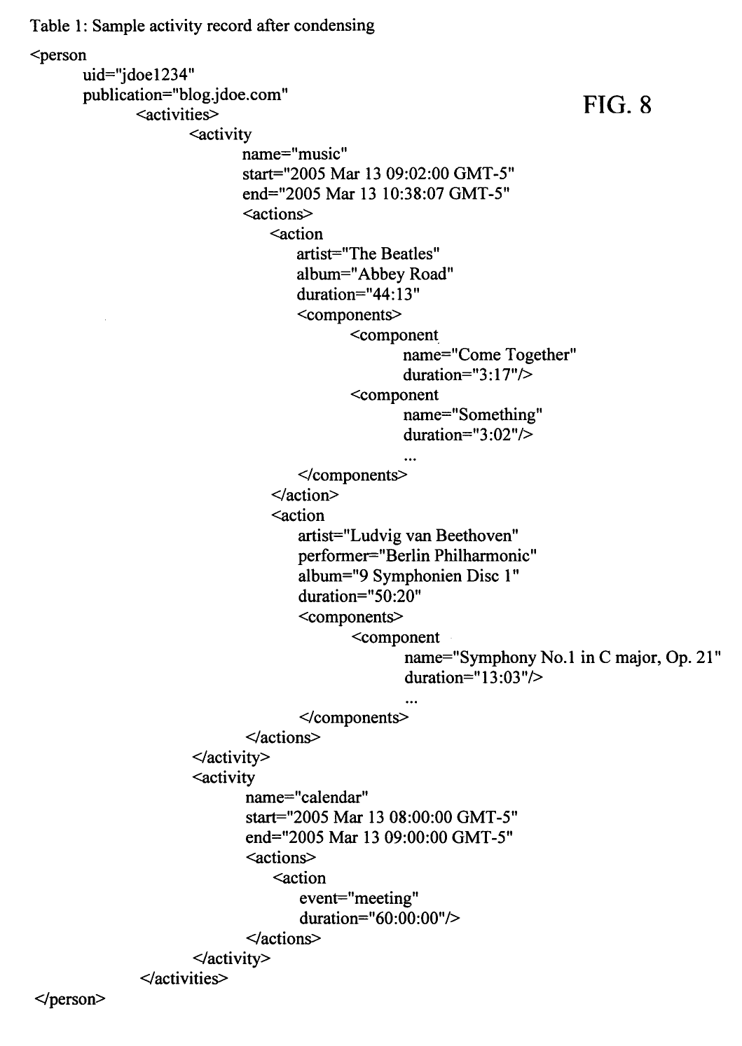

The above-listed sets of observations, which include raw sensor outputs, are combined and condensed into more useful representations. For example, the set of observations taken at the particular polling times of the sensor that the user listened to “Come Together” (e.g. the user was listening to “Come Together” at 9:13:00; the user was listening to “Come Together” at 9:13:10; the user was listening to “Come Together” at 9:13:20) is condensed into the more usefully expressed action (which, as defined above, is any semantically meaningful component of an activity) that the user listened to “Come Together” for 3 minutes and 17 seconds. A sample XML document after condensing the above-listed sets of observations is shown in Table 1 (FIG. 8).

Unit 7 determines the importance of each set of observations. For example, one set of observations may be interpreted as listening to music and another as an event (e.g. a meeting). The importance of the set of observations is calculated based upon how unusual (infrequent) the set of observations is for the individual, and also on how unusual the set of observations is for the population as a whole. A numeric importance value is calculated by combining estimates of how infrequently the individual engages in the activity and how infrequently a larger population engages in the activity. Furthermore, an inference derived from a long span of observations is regarded as being more important than an inference derived from a short span. For example, the inference that someone left for work at 9:15 am (which is derived from, say, one observation) is not as important as the higher-level inference that someone was traveling to work between 9:15 am and 10:15 am (which is derived from several observations). That, in turn, is less important than the inference that the person is late (which is derived from still more observations). Importance determining unit 7 is preferably a Perl program that assigns a numeric importance to each set of observations, and then stores the results in the database 4. The determined importance is shown in Table 2 by the four “weight” attributes.

A sample XML document after weighting is shown in Table 2. The only difference between Tables 1 and 2 is that Table 2 includes weight values. From the weight values provided below, the person seems to listen frequently to the Beatles (assigned a weight of only 0.35), rarely listens to classical music (assigned a higher weight of 0.51), and almost never attends a meeting (assigned a high weight of 0.88).

Composition unit 6 creates a natural language description of all sets of observations that have an importance value above a given threshold. This threshold is an adjustable, or tunable, parameter of the invention. If an individual wishes to “blog” his or her life in minute detail, the threshold is set low. If an individual only wants to “blog” his or her life when something truly unusual occurs, the threshold is set high. The threshold is used to ascribe a prominence to each set of observations proportional to its importance. Server 3 then transmits the description across a communication network 8 to publication 9 and publication 10.

Server 3 invokes the composition unit 6, implemented as a Perl program running on server 3 to generate an English description either when the importance of a set of observations reaches a given threshold, or when a given time limit has elapsed. The resulting descriptions are then transmitted over communications network 8 for publication. In the preferred embodiment, the descriptions are posted to blogs using the Blogger Application Programming Interface (information available at http://www.blogger.com/developers/api).

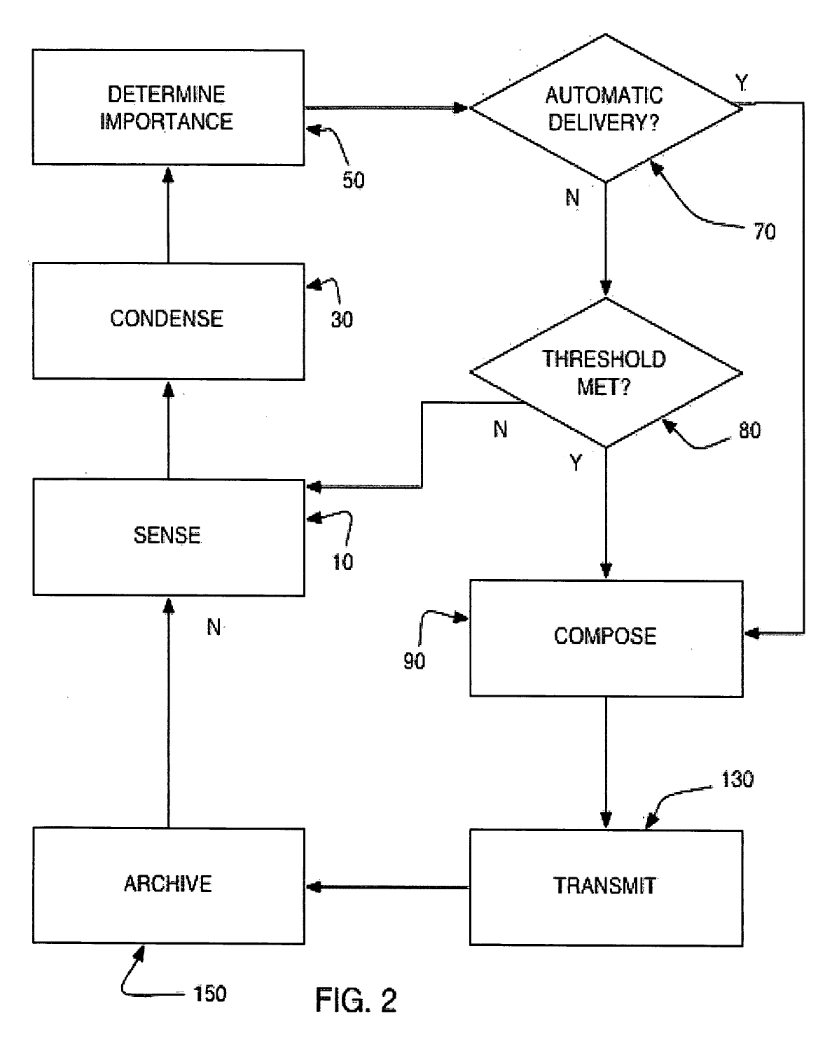

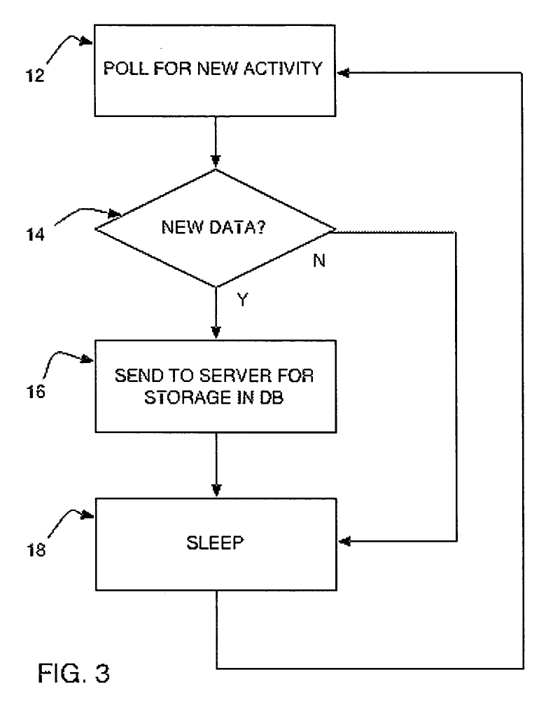

FIG. 2 is a flowchart which is useful for explaining the operations performed by the system of FIG. 1 in accordance with the present invention. Initially, the system has no information about a given person. As observations are gathered by sensors 1, 2 per SENSE step 10 (FIG. 2, and detailed further in FIG. 3) and stored in database 4 (FIG. 1), they are subsequently combined by condensing unit 5 (FIG. 1) with additional observations, per CONDENSE step 30 (FIG. 2), and stored in database 4 (FIG. 1). The condensed results are then assigned weights corresponding to their importance by the importance determining unit 7 (FIG. 1) per DETERMINE IMPORTANCE step 50 (FIG. 2). These weights are inserted into the results and integrated into the database 4 (FIG. 1).

The present invention allows an individual to opt for automatic publication of activity descriptions at regular intervals. This may be through any standard technique in computer applications, such as by web page or electronic mail. If an individual chooses an option specifying periodic publication, as determined per step 70, composition unit 6 (FIG. 1) composes a description per COMPOSE step 90 (FIG. 2) when the interval elapses and transmits the description to the publications via TRANSMIT step 130 (FIG. 2).

If the person did not choose the option for automatic periodic publication, as determined per step 70, descriptions can be composed and transmitted when the importance of a set of observations surpasses a given threshold, as determined per step 80. The threshold may be chosen by default or chosen by the person through any standard technique in computer applications, such as by web page or electronic mail. Once transmission occurs, all observations in the database table of active observations are moved to a database table of archived observations, per ARCHIVE step 150 (FIG. 2).

As shown in FIG. 3, activity sensors 1, 2 (FIG. 1) poll, or sample, at regular intervals the activities in which the person is engaged. The duration of these intervals is a tunable, or adjustable, parameter of the system and defaults to 60 seconds in the present invention. The factors considered in selecting a particular adjustment are system load vs. accuracy for a given sensor. It is possible to conduct th polling every second (or even more frequently), but the computer may then become unusable for anything else. Also, there is no reason to poll the person's calendar, for example, every second since it will not change with anywhere near that frequency. Therefore, once an hour for that activity sensor is adequate. On the other hand, it is advisable to poll a music sensor more frequently because the information can change rapidly. For the music sensor, polling every ten seconds is good, but every minute is acceptable. Per step 12 (FIG. 3), each activity sensor polls the computer application or appropriate source of information about the activity. Such polling may involve, for example, employing a web service or other method of remote procedure calls, examining computer memory, analyzing system logs, or intercepting information sent to a graphical user interface. Per step 14, any new information is then expressed as a simple XML document (the format of which may be inferred from Table 1) and sent to the server per step 16 (FIG. 3) for storage in database 4 (FIG. 1). The sensor then pauses for the remainder of the duration, per SLEEP step 18 (FIG. 3), and then repeats the process.

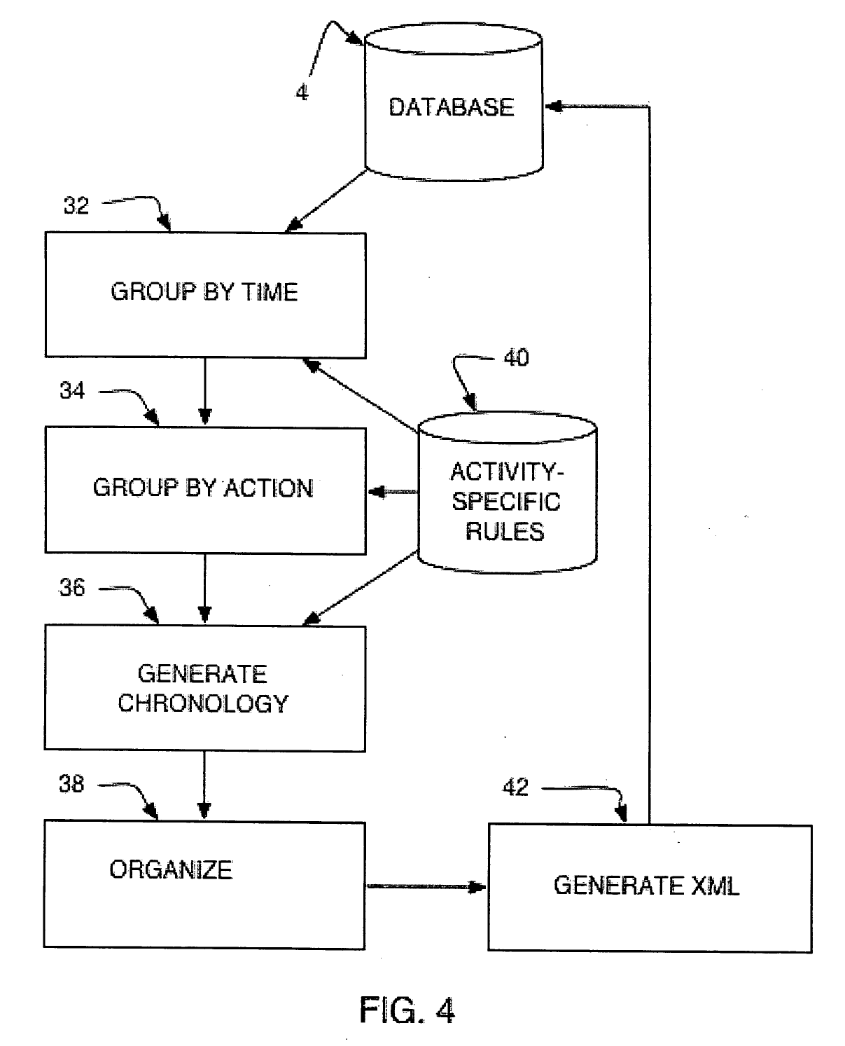

Condensing unit 5 (FIG. 1), per CONDENSE step 30 (FIG. 2), analyzes the observations collected in SENSE step 10. The observations obtained from each sensor are retrieved from database 4, and grouped in a chronological sequence per step 32 (FIG. 4), i.e. observations for the same sensor that happen one after the other, with no other observation in between.

Because sensor observations are susceptible to “clock skew” (defined below), activity-specific rules (discussed below) are used to choose a threshold for each activity that determines when observations should be treated as sequential. This allows for the contingency that, for example, an activity sensor polls an activity in the middle of an action. Clock skew refers to discrepancies arising from use of a plurality of unsynchronized clocks. If person A's watch is two minutes ahead of person B's watch and person A agrees to meet person B precisely at noon, person A and person B will show up at different times. Similarly, say one program says that a person did X at time 12:34:56 and Y at 12:34:58. Another program, running on a different computer with a different clock, says that this person did Z at time 12:34:57, when in fact Z occurred after Y. This is an example of how clock skew can make the sequential observations X and Y seem non-sequential. For example, one audio-specific rule is: “people rarely listen to two things at once.” The following sample observations can be recorded for a person:
09:01:00: Computer A says Person is listening to “Free Culture”, an audiobook
09:02:00: Computer A says Person is listening to “Free Culture”, an audiobook
09:03:00: Computer A says Person is listening to “Free Culture”, an audiobook
09:04:00: Computer A says Person is listening to “Free Culture”, an audiobook
09:04:59: Computer B says Person is listening to “Start it Up”, a song
09:05:00: Computer A says Person is listening to “Free Culture”, an audiobook
09:05:59: Computer B says Person is listening to “Start it Up”, a song
09:06:00: Computer A has no information about what Person is listening to
09:06:59: Computer B says Person is listening to “Start it Up”, a song

If every observation were treated as an absolute, then one could conclude that the person listened to the audio book until 9:04, then started listening to the song, then switched back to the audiobook, then returned to the song. It's more likely, of course, that there is clock skew between computers A and B, and that the person listened to the audiobook and then switched to the song. That's why the audio-specific rule-of-thumb “people rarely listen to two things at once” is useful.

Next, the results for each sensor are grouped by action per step 34 (FIG. 4). Since an action may occur more than once during the duration of time between polls, or polling interval, it is necessary to perform step 32 prior to step 34. The reason that it is important to group by time before grouping by action is because an action (such as listening to an album) can be taken twice. If someone listens to an album twice, it is important to record that as two separate actions, which in turn requires identifying when the album was listened to. For example, if there were no group-by-time step, and a user listened first to album A, then to album B, and then subsequently to album A again, that would be recorded (mistakenly) as only two actions, namely listening to album A and listening to album B, i.e. two actions A, B, rather than the three actions A, B, A.

Some of the observation sets generated by step 32, even if non-contiguous, are merged into a single observation set in this step. The activity-specific rules 40 determine whether to merge observation sets. The setting of appropriate activity-specific rules is self-evident to anyone with ordinary skill in the art and, of course, depends on the activities. One example applies to a person at a meeting. If that person steps out of the meeting to listen to a song and then returns to the meeting, it is still the same meeting, and that person's return should not be treated as a distinct event.

After grouping by action per step 34 is completed, a chronology is generated by placing the results for each person across all sensors in a chronological sequence of activities, per step 36 (FIG. 4). Some activities are not mutually exclusive. When two activities overlap, the activity with the earlier ending time is placed first in the chronology.

The resulting chronology is then organized into a data structure of activities and actions per step 38 (FIG. 4). The data structure is arranged as a directed weighted acyclic graph. This acyclic graph is an intermediate structure used to prepare a more useful XML tree structure as described below. Storing the data structure as a directed weighted acyclic graph makes it possible for the system to extract (via the depth-first search mentioned below) what an individual was doing and when the individual was doing it. Each weight in the acyclic graph corresponds to the duration of time spent on the activity.

The data structure of activities is then converted to an XML format per step 42 (FIG. 4) by searching the acyclic graph using a standard depth-first search and generating the appropriate XML tokens. The XML structure is enclosed in “person” and “activities” tags. The person tag serves to identify the person whose activities are being recorded, and the publications to which the person wants his summaries transmitted. The activities tag serves to group the actions together and allow for future extensibility. The resulting XML document is stored in the database 4, which is depicted above as Table 1.

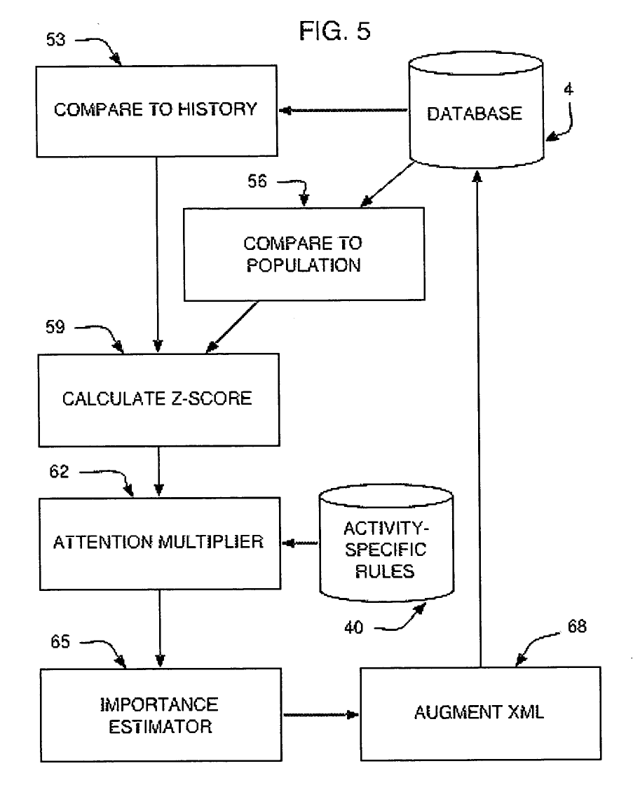

Importance determining unit 7 (FIG. 1), per step 50 (FIG. 2), calculates the importance of each activity and action in the data structure generated by CONDENSE step 30 (FIG. 2). Per step 53 (FIG. 5), the XML document generated with CONDENSE step 30 (FIGS. 2, 4) is retrieved from database 4 (FIG. 1) and compared to earlier XML documents for the person stored per ARCHIVE step 150 (FIG. 2) in the archive, also part of database 4. The frequency of previous occurrences of the activity for the person are fit to a Gaussian distribution. The standard deviation from the mean of the time since the last occurrence is calculated and converted to a standard statistical z-score per step 59. Standard statistical z-scores are well known to anyone with ordinary skill in the art. This z-score identifies how unusual the occurrence of activity is for the person. Similarly, the durations of previous occurrences of the activity for the person are fit to a Gaussian distribution. The standard deviation from the mean of the duration of the current activity is calculated and converted to a standard statistical z-score per step 59. This z-score identifies how unusual the duration of the activity is for the person.

Per step 56, the XML document generated in step 30 is retrieved from the database 4 and compared to earlier XML documents for all persons stored, per ARCHIVE step 150, in the archive, which is a part of database 4. The frequency of previous occurrences of the activity for all persons are fit to a Gaussian distribution. The standard deviation from the mean of the time since the last occurence is calculated and converted to a standard statistical z-score per step 59. This z-score identifies how unusual the occurrence of the activity is across the population of people known to the system. Similarly, the durations of previous occurrences of the activity for all persons are fit to a Gaussian distribution. The standard deviation from the mean of the duration of the current activity is calculated and converted to a standard statistical z-score per step 59. This z-score identifies how unusual the duration of the activity is across the population of people known to the system.

Step 62 is then used to weight the four z-scores resulting from step 59. The weights range from 0 to 1 and are proportional to the amount of a person's attention that each activity requires. For example, many people listen to music while performing other activities, so music listening has a lower attention level compared to driving a car or composing email. These weights are manually adjustable parameters of the system, but default values can be calculated as follows.

The number of times (NP) that the activity occurs for the person is divided by the number of times (NT) that any activity occurs for the person. If the result is significant at the p=0.05 level (p stands for probability and p=0.05 is equivalent to saying “the likelihood that the result is due to chance is no greater than 5%”) using a standard statistical test of significance, that quotient (NP/NT) is used as the multiplier. If the result is not significant at the p=0.05 level, the number of times that the activity occurs for any person known to the system is divided by the number of times that any activity occurs for any person known to the system. If the result is significant at the p=0.05 level using a standard statistical test of significance, that quotient is used as the multiplier. If the result is not significant at the p=0.05 level, a default from the activity-specific rules 40 is used. A default may be implemented using a table that maps activities to preset weights: for example, music listening is 0.1, web surfing is 0.3, etc. The default weights can be built into the system upon configuration, or set later. Either way, a human operator must choose the defaults. If no such default is available, 0.5 is used.

Per step 62 (FIG. 5), each of the z-scores resulting from step 59 is multiplied by the weight obtained for the activity involved to obtain a weighted z-score. This result is listed above in Table 2 as “weight”.

The invention can provide meaningful results if the attention factor were ignored and step 62 skipped. However, the results would be less accurate since the attention factor affects the importance.

Per step 65, the four weighted z-scores resulting from step 62 are used as parameters to a function called the importance estimator, realized in the present invention as a product of exponential expressions of the form Aeˆ(Bx), where A and B are constants, e is the base of the natural logarithm, x is the weighted z-score, and ˆ is the exponentiation operator. Per step 68, the results outputted by the importance-estimator are inserted into the XML document containing the observation sets of the current person. A sample result is shown in Table 2 (see above). The resulting augmented XML document is stored in database 4 (FIG. 1).

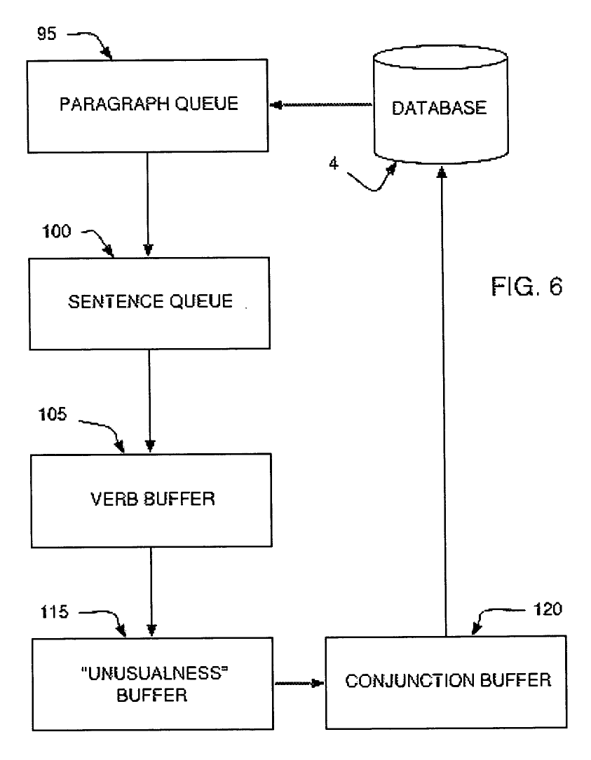

After performing steps 70 and 80 (FIG. 2), server 3 (FIG. 1) converts the XML document into a natural language summary of the activities of the person using the weights calculated per COMPOSE step 90 (FIGS. 2, 6). This conversion happens only if the person requested automatic delivery and the interval specified by the person has elapsed, or if the sum of weights for each activity is one standard deviation above the mean sum of weights for each activity for the person. Of course, as described above, this threshold is adjustable. By increasing this threshold (say, to two standard deviations) fewer activities will be deemed important (that is, fewer activities will reach a given importance level). Conversely, by decreasing the threshold (say, to one half of a standard deviation), more activities will be deemed important.

Composition unit 6 (FIG. 1) proceeds per step 95 (FIG. 6) to analyze the XML documents resulting from the IMPORTANCE DETERMINING step 50 (FIG. 2). The XML document describing the current activities of the user is retrieved from the database 4. The sum of weights for each activity is calculated, and the weight for each activity is divided by this sum to arrive at a normalized weight. A standard pseudorandom number generator is used to select activities from the XML document with a likelihood proportional to their normalized weight. The resulting selections are placed in a queue data structure. The construction of the queue in this manner is to ensure that the order of activity descriptions in the summary reflects their importance to the user without being exactly the same each time, to avoid monotony in the publication. Each activity results in a paragraph in the description generated by step 95. Subsequent steps 100, 105 and 115 generate the sentences that constitute each paragraph.

Within each paragraph, the order of sentences is determined per step 100 by a similar process to step 95. Each activity, and component (e.g. action) within an activity with a weight higher than a given threshold, results in a sentence. The sum of weights for each component in an activity is calculated, and the weight for each component is divided by this sum to arrive at a normalized weight. A standard pseudorandom number generator is used to select components from the XML document with a likelihood proportional to their normalized weight. The resulting selections are placed in a queue data structure. The construction of the queue in this manner is to ensure that the order of component descriptions in the summary reflects their importance to the user without being exactly the same each time, to avoid monotony in the description.

Per step 105, the system maintains a circular verb buffer for each category of activity. For instance, the buffer for listening verbs in English contains words such as “listened”, “heard”, and “experienced”, as well as conjoining verb/preposition pairs for clauses after the first, such as “switched to” and “changed to”. Such lists can be built into the system or generated via an online thesaurus/lexical database such as WordNet (available at http://www.coqsci.princeton.edu/˜wn/). The buffer is randomized at the beginning of step 105, and cycled until a non-conjoining verb becomes the initial element. Examples of non-conjoining verbs are “I listened”, “I heard”, “I experienced”. Each sentence created by step 100 is given a single verb from the beginning of the queue, prefaced with “I”. That verb is then moved to the end of the queue to avoid monotony in the description.

Per step 115, the system maintains a circular phrase buffer for categories of unusualness. For instance, actions that are somewhat unusual (determined from the result of step 50) result in adverbs or phrases such as “For a change”, “As usual”, “As expected”, and “For the first time”. The buffer is randomized at the beginning of step 115. A fixed percentage (defaulting to 20%) of the sentences are given a phrase in this step, either at the beginning or the end of the sentence with equal likelihood. Standard capitalization and grammar rules are followed.

Per step 120, the paragraphs and sentences within them are joined together with natural conjunctions appropriate to the temporal distance between the activities such as “At the same time”, “Next”, “Finally”, “Later”, “Much later”, “The next day”. For each category of temporal distance, a randomized circular buffer of conjunctions is created. When a conjunction is needed, the conjunction from the appropriate buffer is inserted into the natural language description and subsequently moved to the end of the buffer so that it is not used again until all other alternatives have been exhausted. Commas, semicolons, and periods are used to separate conjunctions per standard rules of grammar. The resulting natural language description is stored briefly in the database 4 for transmission by the server 3 to publications.

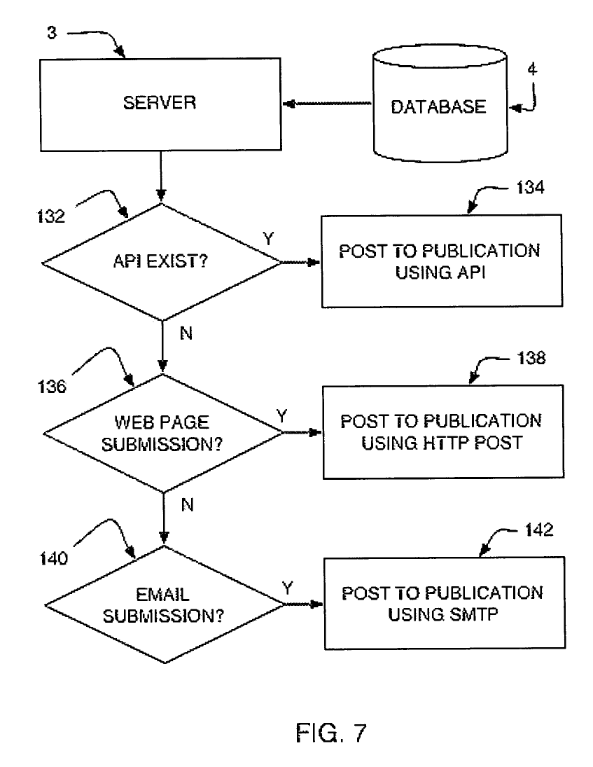

Server 3 (FIG. 1), per TRANSMIT step 130 (FIGS. 2, 7), transmits the summary resulting from COMPOSE step 90 over communications network 8 to the publications. The server 3 retrieves the natural language description stored in the database 4 and generated by the COMPOSE step 90. For each publication that the person has chosen for transmission of activity summaries, the server first determines per step 132 whether an API for submissions exists, such as the B logger API for blog publications. If an API exists, the server uses it to post the summary per step 134. In the preferred embodiment, this is done using a Perl program that imports the Net::Blogger Perl module (available at http://search.cpan.org). If no API exists, the server determines per step 136 whether the publication accepts web page submissions. If so, the server uses the POST method of the Hypertext Transfer Protocol (HTTP) to submit the summary per step 138. In the preferred embodiment, this is done using a Perl program that imports a Perl LWP bundle (available at http://search.cpan.org).

If web page submission is not possible, the server determines per step 140 whether the publication accepts electronic mail submissions. If so, the server uses the Simple Mail Transfer Protocol to submit the summary per step 142. In the preferred embodiment, this is done using a Perl program that imports the Mail::Sendmail module (available at http://search.cpan.org).

Although a preferred embodiment of the present invention has been described above in detail, various modifications thereto will be readily apparent to anyone with ordinary skill in the art. For example, the present invention may be implemented in either hardware or software, or using a combination of both. Also, the composition unit in the present invention may generate natural languages other than English. Further, the composition unit may use text-to-speech technology to generate a spoken-word audio summary of the activities of the person. In addition, the importance determining unit may use distributions other than Gaussian to calculate the z-scores. All such variations are intended to fall within the scope of the present invention as defined by the following claims.

I claim:

1. A computerized method for automatically composing a natural language summary of a person's activities, comprising:
obtaining data related to activities in which the person has engaged;
distinguishing more meaningful data from less meaningful data contained in the obtained data; and
composing a natural language summary of the person's activities from said more meaningful data.

2. The method of claim 1, wherein the step of obtaining data comprises making measurements automatically with activity sensors to output a machine-readable signal.

3. The method of claim 2, wherein the step of obtaining data comprises automatically making the measurements with said activity sensors at preset periodic time intervals.

4. The method of claim 3, wherein the step of obtaining data comprises organizing the obtained data as a function of time.

5. The method of claim 4, wherein the step of gathering data comprises organizing the obtained data as a function of activities.

6. The method of claim 2, wherein the step of distinguishing more meaningful data from less meaningful data comprises:
organizing said obtained data into sets of sensor observations; and
determining a relative importance value for each of said sets of sensor observations.

7. The method of claim 6, further comprising the step of obtaining a value related to the amount of a person's attention required by a particular activity; and
wherein the step of determining a relative importance value applies the obtained attention value obtained for the particular activity.

8. The method of claim 6, wherein the composing step comprises composing a natural language summary for only sets of sensor observations having a relative importance value that exceeds a preset threshold.

9. The method of claim 1, further comprising the step of transmitting the natural language summaries for publication.

10. A method, based on using data obtained about activities engaged in by a person, for distinguishing more meaningful data from less meaningful data contained in the obtained data, comprising the steps of:
for each activity, determining a first weight based on the history of the person;
for each activity, determining a second weight based on the history of a population; and
for each activity, combining the first and second weights to derive an importance value.

11. The method of claim 10, wherein the first weight for a particular activity is determined based on occurrences of such activity in the history of the person.

12. The method of claim 10, wherein the first weight for a particular activity is determined based on durations for such activity in the history of the person.

13. The method of claim 10, wherein the second weight for a particular activity is determined based on occurrences of such activity in the history of the population.

14. The method of claim 10, wherein the second weight for a particular activity is determined based on durations for such activity in the history of the population.

15. The method of claim 10, further comprising the steps of:
obtaining a value related to the amount of a person's attention required by a particular activity; and
wherein said step of deriving an importance value comprises combining the obtained attention value obtained for the particular activity with the first and second weights determined for the particular activity.

16. A method, based on using data obtained about at least one activity engaged in by a person, for automatically composing a natural language summary of such at least one activity, comprising the steps of:
creating a paragraph structure related to the at least one activity;
creating a sentence structure to respectively summarize at least a component of the at least one activity, wherein the natural language used in the sentences is based on the obtained data;
selecting verbs for insertion into said sentence structure; and
selecting conjunctions for joining the paragraphs and/or sentences to form the summary.

17. The method of claim 16, wherein the paragraphs are chosen via a queue ordered by relative importance of an activity in comparison with the person's other activities.

18. The method of claim 16, wherein the paragraphs are chosen via a queue randomly ordered with likelihoods related to relative importance of an activity in comparison with the person's other activities.

21. The method of claim 16, wherein the sentences are chosen via a queue randomly ordered with likelihoods related to relative importance of an activity in comparison with the person's other activities.

22. The method of claim 16, wherein the verbs are chosen via a randomized circular buffer.

23. The method of claim 16, wherein the phrases are chosen via a randomized circular buffer.

24. The method of claim 16, wherein the conjunctions are chosen via a randomized circular buffer.

25. The method of claim 16, further comprising the step of selecting for the paragraphs and/or sentences introductory phrases corresponding to an aspect of activity usage related to unusualness.
